(19) United States
(12) Patent Application Publication
(10) Pub. No.: US 2010/0125117 A1
(43) Pub. Date: May 20, 2010

(54) Surface-Treated Titanium Dioxide Pigments for Plastics and Method for Production

(76) Inventors: Lydia Drews-Nicolai, Koln (DE); Stephen Peter Blöss, Burscheid (DE); Volker Jürgens, Kirchhundem (DE); Tino Kuln, Sankt Augustin (DE)

Correspondence Address: Locke Lord Bissell & Liddell LLP;Attn: Michael Ritchie, Docketing, 2200 Ross Avenue, Suite # 2200, DALLAS, TX, 75201-6776, US

(21) Appl. No.: 12/619,834

(22) Filed: Nov. 17, 2009

Related U.S. Application Data
(60) Provisional application No. 61/117,326, filed on Nov. 24, 2008.

(30) Foreign Application Priority Data
Nov. 20, 2008 (DE) 2008.058.351.0

(51) Int. Cl. C08K 3/22; B05D 7/00

(52) U.S. Cl. 524/413; 427/214

(57) ABSTRACT

A weather-resistant titanium dioxide pigment particularly suitable for use in engineering plastics, as well as to a method for its manufacture and to polymers containing the pigment. The titanium dioxide is provided with a surface coating that, from the inside to the outside, displays a SiO₂ layer, an Al₂O₃ layer and an organic layer, where the maximum total Al₂O₃ content is 2.4% by weight and the organic layer contains at least one compound from the group comprising H-siloxanes, silicone oils and organically functionalised polysiloxanes. The manufacturing method is characterised in that an aqueous suspension of Al-doped titanium dioxide particles is milled in an agitator mill, and a SiO₂ layer and an Al₂O₃ layer are then applied in batch mode, after which an organic layer is applied that contains at least one compound from the group comprising H-siloxanes, silicone oils and organically functionalised polysiloxanes.

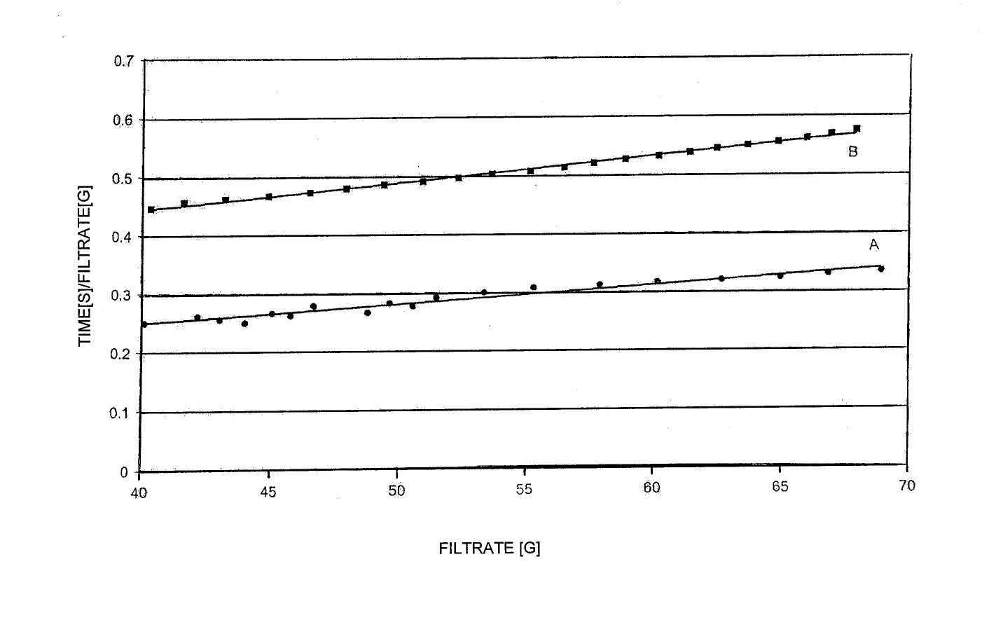

### RELATED APPLICATION

This application claims the benefit of U.S. Provisional Patent Application Ser. No. 61/117,326 filed Nov. 24, 2008 and claims priority to German Patent Application Serial No. 2008.058.351.0 filed Nov. 20, 2008.

### TECHNICAL FIELD OF THE INVENTION

The invention relates to titanium dioxide pigments that are particularly suitable for use in plastics, a method for manufacturing them, and a polymer compound containing these pigments.

### BACKGROUND OF THE INVENTION

Plastics encompass a host of different polymers, a distinction particularly being made between commodity plastics, such as polyethylene, polypropylene, polyvinyl chloride, polystyrene or polyurethane, and engineering plastics. Engineering plastics are characterised by special mechanical and thermal properties, by chemical stability and low flammability. Examples of engineering plastics include polycarbonate, polyamide, polyester, polyoxymethylene and acrylonitrile-butadiene-styrene.

Polycarbonate is an engineering plastic that is used for a wide variety of purposes because of its properties, e.g. in the automotive sector, electrical engineering, Compact Disc (CD) production, domestic appliances, electronic components and many other sectors.

Polycarbonate is a predominantly amorphous, transparent, hard-elastic plastic and, owing to its low water absorption, is suitable as a material for precision components, in particular. In addition, polycarbonate is characterised by particularly good basic properties, such as high toughness and a high heat deflection temperature, as well as good processability.

The properties of the plastic can be extensively controlled by using additives. Polycarbonate is coloured using not only classical colour pigments, but also titanium dioxide pigments and effect pigments. In polycarbonate coloured with pigments, the OH groups on the pigment surface play a role because, even after drying of the pigment and the polycarbonate, they can lead to damage to the polycarbonate during production of the engineering plastic and/or during its further processing. It is known that the addition of H-siloxanes can counteract the damaging of the polycarbonate in such cases. Commercially available stabilisers, such as phosphites, epoxides, etc., cannot completely prevent this polymer degradation.

The demands on a TiO₂ pigment for use in engineering plastics, especially in polycarbonate, consist not only in the optical properties, but also in good processability and thermostability of the plastic. A number of commercial pigments offering a pigment surface functionalised with H-siloxanes exist for use in polycarbonate, such as the KRONOS pigment grades K2230 and K2233. They are, however, characterised by low weather resistance.

It is known practice to improve the weather resistance of TiO₂ pigments by applying a dense SiO₂ skin and, where appropriate, a further skin of Al₂O₃. The classical surface treatment methods for TiO₂ operate in batch mode, in which context an aqueous suspension of TiO₂ particles is mixed with a solution of the coating substance in a mixing tank, and the pH value set in such a way that the substance is deposited on the particle surface. Methods of this kind are known from U.S. Pat. No. 3,437,502 or EP 0 409 879 B1, for example.

For incorporation in polymers, the pigment particle surface is usually additionally treated with an organic substance to improve dispersibility and processability (e.g. U.S. Pat. No. 7,011,703 B1).

WO 2008/071382 A1 teaches an alternative procedure for producing an inorganic surface coating with a dense SiO₂ skin and a subsequent Al₂O₃ skin. According to one embodiment of this method, the dense SiO₂ skin is deposited on the particle surface in a continuous process during sand-milling of the TiO₂ base material, this achieving a very homogeneous skin (small specific surface area) and improved tinting strength of the pigment. On the other hand, the method according to WO 2008/071382 A1 has disadvantages as regards filtering of the pigment filter cake.

EP 1 760 116 A1 describes a titanium dioxide pigment, specifically for use in engineering plastics, that displays an SiO₂ coating and an organic coating. The organic coating is applied directly to the SiO₂ coating in this context. An Al₂O₃ layer between the SiO₂ coating and the organic coating is said to be disadvantageous, this being documented by corresponding reference examples. The organic coating substances indicated are trimethylolpropane, trimethylolethane, alkylsilanes with 4 to 10 carbon atoms, polydimethylsiloxane and polymethylhydrogensiloxane. Particularly for use in polycarbonate, the organic coating consists of polymethylhydrogensiloxane. Among other things, the weather resistance of the plastics manufactured using these TiO₂ pigments is emphasised as being advantageous. The absence of thermally induced discolouration is said to be advantageous, specifically for use in polycarbonate.

### SUMMARY OF THE INVENTION

A need exists for a titanium dioxide pigment with good optical properties and high weather resistance that, particularly when used in engineering plastics, leads to good processing stability of the plastic and good properties of the end product, and a manufacturing method for a titanium dioxide pigment of this kind.

One aspect of the present invention is a surface-treated titanium dioxide pigment, characterised in that an SiO₂ layer, an Al₂O₃ layer and an organic layer are applied consecutively around the pigment particles, from the inside to the outside, wherein the organic layer contains at least one compound from the group comprising H-siloxanes, silicone oils and organically functionalised polysiloxanes, and wherein the maximum total Al₂O₃ content of the particles is 2.4% by weight, referred to total pigment.

An additional aspect of the present invention is a method for manufacturing surface-treated titanium dioxide pigment particles, characterised by the following steps:

a) Subjecting an aqueous suspension of Al-doped titanium dioxide particles to agitator milling,
b) Applying an SiO₂ layer and an Al₂O₃ layer to the titanium dioxide particles in batch mode, wherein the maximum total Al₂O₃ content of the particles is 2.4% by weight, referred to total pigment, and
c) Subsequently applying an organic layer, comprising at least one compound from the group comprising H-siloxanes, silicone oils and organically functionalised polysiloxanes, to the titanium dioxide particles.

A further aspect of the present invention uses surface-treated titanium dioxide particles in engineering plastics, wherein an SiO₂ layer, an Al₂O₃ layer and an organic layer are applied consecutively to the particle surface, from the inside to the outside,
wherein the organic layer contains at least one compound from the group comprising H-siloxanes, silicone oils and organically functionalised polysiloxanes, and wherein the maximum total Al₂O₃ content of the particles is 2.4% by weight, referred to total pigment.

Further advantageous embodiments of the invention are described herein.

### BRIEF DESCRIPTION OF THE DRAWING

For a more complete understanding of the present invention and for further advantages thereof, reference is now made to the following description taken in conjunction with the accompanying drawing in which:

The FIGURE illustrates a portion of a filtrate curve comparing the present method to a prior art method.

### PREFERRED EMBODIMENTS

The subject matter of the invention is a weather-resistant titanium dioxide pigment that is readily dispersible and suitable for use in plastics, especially in engineering plastics.

Within the scope of the invention, “engineering plastics” is taken to mean polycarbonate, polyoxymethylene, polyamide, polyester and acrylonitrile-butadiene-styrene, for example, although this is not to be interpreted as a limitation.

Moreover, within the scope of the invention, the oxides SiO₂, Al₂O₃, etc. are taken to also mean the respective hydrous oxides.

All data disclosed below regarding pH value, temperature, concentration in % by weight or % by volume, etc., are to be interpreted as also including all values lying in the range of the respective measuring accuracy known to the person skilled in the art.

The pigment particles according to the invention are provided, from the inside to the outside, with a SiO₂ layer, an Al₂O₃ layer and an organic layer. The quantity of the SiO₂ layer is preferably 0.5 to 5.0% by weight SiO₂, particularly 2.0 to 2.5% by weight SiO₂, referred to total pigment. The quality of the SiO₂ layer can be referred to as a dense layer. The layer is preferably dense according to the acid solubility test described in Silicic Acid as Component of Titanium Dioxide Pigments by Dr. Helmut Weber, Kronos Titan-GMBH, Scientific Department, P.O. Box 10 07, D-5090 Leverkusen 1. In other words, the sulphuric acid solubility of the SiO₂ encapsulated TiO₂ pigment is preferably less than about 10% by weight.

The total aluminium content of the pigment is a maximum of 2.4% by weight, calculated as Al₂O₃ and referred to total pigment, preferably a maximum of 2.0% by weight, and particularly 1.6 to 1.8% by weight Al₂O₃. Aluminium contents in excess of 2.4% by weight Al₂O₃ impair the processing stability of the plastic and the properties of the end product.

The TiO₂ pigment particles according to the invention are provided, on the outside, with an organic layer containing at least one compound from the group comprising H-siloxanes, silicone oils and organically functionalised polysiloxanes. A suitable H-siloxane is, for example, polymethylhydrogensiloxane. Within the scope of the invention, “silicone oils” is taken to mean, for example, polydimethylsiloxanes, polymethylalkylsiloxanes with C2-C14 alkyl groups or polymethylphenylsiloxanes, as well as, for example, dimethylsiloxane-based copolymers with methylalkylsiloxanes with C2-C14 alkyl groups and methylphenylsiloxanes. Within the scope of the invention, “organically functionalised polysiloxanes” is taken to mean polysiloxanes containing organic groups, such as alkyl, alkoxy, vinyl or amino groups. This exemplary list is not, however, to be interpreted as a limitation of the invention.

In a special embodiment of the invention, the organic layer consists of polymethylhydrogensiloxane and polydimethylsiloxane.

The subject matter of the invention is also a method based on an aqueous suspension of untreated titanium dioxide particles (TiO₂ base material). The particles preferably originate from the chloride process for manufacturing TiO₂ and are doped with aluminium. The aluminium doping is customarily in the region of about 0.8 to 1.5% by weight, calculated as Al₂O₃ preferably in the region of about 1.2% by weight Al₂O₃.

The aqueous suspension of titanium dioxide particles is milled in an agitator mill in the manner familiar to the person skilled in the art. For example, a pH value of about 11 is set prior to milling.

The milled suspension is transferred to a mixing vessel and heated to a temperature of about 40 to 90° C., preferably 60 to 80° C. The particles are subsequently provided with a dense SiO₂ skin, followed by an Al₂O₃ skin, in a batch process.

Alkali silicate is first added to the suspension in the form of sodium or potassium water glass. It is added in one or several stages, using known technical methods. The quantity added is preferably 0.5 to 5.0% by weight SiO₂, particularly 2.0 to 2.5% by weight SiO₂, referred to total pigment. The pH value is subsequently lowered to about 3 to 8, preferably about 4, by adding suitable substances. The person skilled in the art is familiar with corresponding suitable substances for lowering the pH value, e.g. HCl.

An Al₂O₃ precursor, such as sodium aluminate, is subsequently added to the suspension. It is added in one or several stages, using known technical methods. A preferred embodiment is the addition of an alkaline Al compound, such as sodium aluminate, in a fixed pH value range, preferably in the range from 4 to 7, by parallel addition of an acidic compound, such as HCl or aluminium sulphate. The quantity added is preferably 0.1 to about 1.0% by weight Al₂O₃, referred to total pigment, particularly 0.2 to 0.6% by weight Al₂O₃. If required, the pH value is subsequently set to between 4 and 8, preferably with NaOH/HCl or with sodium aluminate/aluminium sulphate. The total quantity of Al₂O₃, including the aluminium doping of the base material, should not exceed 2.4% by weight, referred to total pigment.

The surface-treated TiO₂ pigment particles are subsequently separated from the suspension by filtration, and the filter cake is optionally washed to remove water-soluble salts. The pigment is then dried using technically familiar driers (e.g. spray driers, plate driers). This can optionally be followed by thermal treatment at temperatures of 200 to 600° C., preferably 300 to 500° C., in customary apparatus, such as a rotary kiln.

Finally, an organic skin is applied to the TiO₂ pigment particles. The organic skin contains at least one compound from the group comprising H-siloxanes, silicone oils and organically functionalised polysiloxanes. Polymethylhydrogensiloxane is, for example, a suitable H-siloxane. Silicone oils that can be used include, for example, polydimethylsiloxane or polymethylalkylsiloxanes with C2-C14 alkyl groups or polymethylphenylsiloxanes, as well as, for example, dimethylsiloxane-based copolymers with methylalkylsiloxanes with C2-C14 alkyl groups and methylphenylsiloxanes. Suitable organically functionalised polysiloxanes are, for example, functionalised silanes containing vinyl, alkyl, alkoxy or amino groups. This exemplary list is not, however, to be interpreted as a limitation of the invention.

In a special embodiment of the invention, polymethylhydrogensiloxane and polydimethylsiloxane are used.

Organic coating advantageously takes place during fine grinding of the pigment, which is customarily performed in a steam jet mill, but can also be performed using other apparatus suitable for organic coating. For organic coating with the help of a steam jet mill, the organic coating substances are fed into the steam mill at the same time as the pigment. The finished pigment preferably contains 0.05 to 1% by weight carbon, particularly 0.1 to 0.6% by weight carbon, referred to pigment.

In comparison with TiO₂ pigments surface-coated with equal quantities of SiO₂ and Al₂O₃ in accordance with WO 2008/071382 A1, the pigments treated according to the invention display better filterability of the filter cake, this making it possible to realise higher filtration capacities.

The filter cake resistance is suitable as a measure of the throughput achievable in a filtration process forming a filter cake, and can be determined in accordance with VDI Guideline 2762 (February 1997) on the basis of laboratory tests. An overview of the design and evaluation of tests of this kind can be found in the publication by J. W. Tichy “Ausgelegt and optimiert. Genaue Filterversuche zur Fest-Flüssig-Trennung” [“Designed and optimised. Accurate filter tests for solid-liquid separation.”] (CITplus 10/2005, p. 62-63). The customary method in the case of filtration at constant pressure and constant solids content is to draw up the filtrate curve over time. The FIGURE shows a section of the filtrate curve, A, when using the present method in comparison with use of the method described in WO 2008/071382 A1, curve B. According to the filter theory (see J. W. Tichy, p. 63), the slope of the curve is proportional to the filter cake resistance. The present method is, therefore, characterised by a lower filter cake resistance.

Surprisingly, the TiO₂ pigment particles manufactured according to the invention are not only more readily filterable, but also lead, when used in engineering plastics, particularly in polycarbonate, to no disadvantages whatsoever in relation to the optical properties or thermal stability of the plastics compared to the pigments manufactured according to WO 2008/071382 A1 (see Example 4 and Reference Example 2).

Titanium dioxide pigment particles provided, from the inside to the outside, with a dense SiO₂ layer, an Al₂O₃ layer and an organic layer, where the organic layer contains at least one compound from the group comprising H-siloxanes, silicone oils and organically functionalised polysiloxanes, and where the total Al₂O₃ content of the particles is a maximum of 2.4% by weight, referred to total pigment, are highly suitable for use in engineering plastics, particularly in polycarbonate.

The subject matter of the invention is also a polymer compound, preferably an engineering plastic, comprising the particles of the invention. For example, the invention includes polycarbonate, polyamide, polyester, polyoxymethylene and acrylonitrile-butadiene-styrene compounds and mixtures thereof comprising the particles of the invention.

### EXAMPLES

The invention is explained in more detail below on the basis of a number of examples, although these are not to be interpreted as a limitation. The quantities given refer in each case to the TiO₂ base material, unless otherwise indicated.

### Example 1

### SiO₂ and Al₂O₃ Layer Only

A sand-milled, aqueous suspension of TiO₂ base material—which displayed an Al₂O₃ content of about 1.2% by weight and was manufactured by the chloride process—with a TiO₂ concentration of 350 g/l was set to a pH value of 11 with NaOH at 70° C. While stirring, 2.2% by weight SiO₂ was added to the suspension in the form of sodium water glass. After stirring for 15 minutes, the pH value was lowered to a value of 4 within 70 minutes while stirring.

After stirring for a further 15 minutes, 0.4% by weight Al₂O₃ was added in the form of sodium aluminate, the pH value being maintained at a value of 4 by parallel addition of HCl. After stirring for a further 15 minutes, the pH value was set to a value of 5.5 with 0.1% by weight Al₂O₃ in the form of sodium aluminate.

After stirring for a further 30 minutes, the TiO₂ suspension was filtered and then washed to remove water-soluble salts. The washed filter paste was dried in a plate drier at 160° C. and subsequently subjected to thermal treatment at 420° C. for 2 hours.

To test the specific surface area (BET), the product was ground in a mortar mill (Pulverisette) at a rate of 10 g/10 min.

### Example 2

A sand-milled, aqueous suspension of TiO₂ base material—which displayed an Al₂O₃ content of about 1.2% by weight and was manufactured by the chloride process—with a TiO₂ concentration of 350 g/l was set to a pH value of 11 with NaOH at 70° C. While stirring, 2.2% by weight SiO₂ was added to the suspension in the form of sodium water glass. After stirring for 15 minutes, the pH value was lowered to a value of 4 within 70 minutes while stirring.

After stirring for a further 15 minutes, 0.4% by weight Al₂O₃ was added in the form of sodium aluminate, the pH value being maintained at a value of 4 by parallel addition of HCl. After stirring for a further 15 minutes, the pH value was set to a value of 5.5 with 0.1% by weight Al₂O₃ in the form of sodium aluminate.

After stirring for a further 30 minutes, the TiO₂ suspension was filtered and then washed to remove water-soluble salts. The washed filter paste was dried in a spray drier at 110° C. and subsequently subjected to thermal treatment at 420° C. for 2 hours. The thermally treated product subsequently underwent steam milling with added polymethylhydrogensiloxane. The carbon content of the TiO₂ particles was 0.2% by weight, referred to pigment.

### Example 3

A sand-milled, aqueous suspension of TiO₂ base material—which displayed an Al₂O₃ content of about 1.2% by weight and was manufactured by the chloride process—with a TiO₂ concentration of 350 g/l was set to a pH value of 11 with NaOH at 70° C. While stirring, 2.2% by weight SiO₂ was added to the suspension in the form of sodium water glass. After stirring for 15 minutes, the pH value was lowered to a value of 4 within 70 minutes while stirring.

After stirring for a further 15 minutes, 0.4% by weight Al₂O₃ was added in the form of sodium aluminate, the pH value being maintained at a value of 4 by parallel addition of HCl. After stirring for a further 15 minutes, the pH value was set to a value of 5.5 with 0.1% by weight Al₂O₃ in the form of sodium aluminate.

After stirring for a further 30 minutes, the TiO₂ suspension was filtered and then washed to remove water-soluble salts. The washed filter paste was dried in a plate drier at 160° C. The dried product subsequently underwent steam milling with added polymethylhydrogensiloxane (0.3% by weight C, referred to pigment) and polydimethylsiloxane (0.1% by weight C, referred to pigment). The carbon content of the TiO₂ particles was 0.4% by weight, referred to pigment.

### Example 4

A sand-milled, aqueous suspension of TiO₂ base material—which displayed an Al₂O₃ content of about 1.2% by weight and was manufactured by the chloride process—with a TiO₂ concentration of 350 g/l was set to a pH value of 11 with NaOH at 70° C. While stirring, 2.2% by weight SiO₂ was added to the suspension in the form of sodium water glass. After stirring for 15 minutes, the pH value was lowered to a value of 4 within 70 minutes while stirring.

After stirring for a further 15 minutes, 0.4% by weight Al₂O₃ was added in the form of sodium aluminate, the pH value being maintained at a value of 4 by parallel addition of HCl. After stirring for a further 15 minutes, the pH value was set to a value of 5.5 with 0.1% by weight Al₂O₃ in the form of sodium aluminate.

After stirring for a further 30 minutes, the TiO₂ suspension was filtered and then washed to remove water-soluble salts. The washed filter paste was dried in a plate drier at 160° C. The dried product subsequently underwent steam milling with added polymethylhydrogensiloxane (0.3% by weight C, referred to pigment) and polydimethylsiloxane (0.3% by weight C, referred to pigment). The carbon content of the TiO₂ particles was 0.6% by weight, referred to pigment.

### Reference Example 1

A sand-milled, aqueous suspension of TiO₂ base material—which displayed an Al₂O₃ content of about 1.2% by weight and was manufactured by the chloride process—with a TiO₂ concentration of 350 g/l was set to a pH value of 11 with NaOH at 70° C. While stirring, 2.2% by weight SiO₂ was added to the suspension in the form of sodium water glass. After stirring for 15 minutes, the pH value was lowered to a value of 4 within 70 minutes while stirring.

After stirring for a further 15 minutes, a pH value of 7 was set with NaOH. The TiO₂ suspension was filtered and then washed to remove water-soluble salts. The washed filter paste was dried in a plate drier at 160° C.

To test the specific surface area (BET), the product was ground in a mortar mill (Pulverisette) at a rate of 10 g/10 min.

### Reference Example 2

An aqueous suspension of TiO₂ base material—which displayed an Al₂O₃ content of about 1.2% by weight and was manufactured by the chloride process—with a TiO₂ concentration of 500 g/l was set to a pH value of 11.5 with NaOH. While stirring, 0.5% by weight SiO₂ was added to the suspension in the form of sodium water glass. The suspension was subsequently ground in a vertical sand mill (Model PM5, Draiswerke GmbH) at a rate of 5 kg/h.

The suspension was subsequently diluted to 350 g/l with water and heated to 70° C. 1.7% SiO₂ was added in the form of sodium water glass, and a pH value of 4 was set with HCl within 70 minutes while stirring.

After stirring for a further 15 minutes, 0.4% by weight Al₂O₃ was added in the form of sodium aluminate, the pH value being maintained at a value of 4 by parallel addition of HCl. After stirring for a further 15 minutes, the pH value was set to a value of 5.5 with 0.1% by weight Al₂O₃ in the form of sodium aluminate.

After stirring for a further 30 minutes, the TiO₂ suspension was filtered and then washed to remove water-soluble salts. The washed filter paste was dried in a plate drier at 160° C. The dried product subsequently underwent steam milling with added polymethylhydrogensiloxane (0.3% by weight C, referred to pigment) and polydimethylsiloxane (0.1% by weight C, referred to pigment). The carbon content of the TiO₂ particles was 0.4% by weight, referred to pigment.

### Reference Example 3

A sand-milled, aqueous suspension of TiO₂ base material—which displayed an Al₂O₃ content of about 1.2% by weight and was manufactured by the chloride process—with a TiO₂ concentration of 350 g/l was set to a pH value of 11 with NaOH at 70° C. While stirring, 2.2% by weight SiO₂ was added to the suspension in the form of sodium water glass. After stirring for 15 minutes, the pH value was lowered to a value of 4 within 70 minutes while stirring.

After stirring for a further 15 minutes, 1.9% by weight Al₂O₃ was added in the form of sodium aluminate, the pH value being maintained at a value of 4 by parallel addition of HCl. After stirring for a further 15 minutes, the pH value was set to a value of 5.5 with 0.1% by weight Al₂O₃ in the form of sodium aluminate.

After stirring for a further 30 minutes, the TiO₂ suspension was filtered and then washed to remove water-soluble salts. The washed filter paste was dried in a plate drier at 160° C. The dried product subsequently underwent steam milling with added polymethylhydrogensiloxane (0.3% by weight C, referred to pigment) and polydimethylsiloxane (0.3% by weight C, referred to pigment). The carbon content of the TiO₂ particles was 0.6% by weight, referred to pigment.

### Test Methods

### Sulphuric Acid Solubility:

The sulphuric acid solubility test is used as a measure of the quality of the SiO₂ coating of the pigment. A suspension of 500 mg pigment in 25 ml concentrated sulphuric acid (96%) is kept at 175° C. for 60 minutes. After filtration, the dissolved TiO₂ in the filtrate is determined by means of ICP atomic emission spectrometry. The lower the concentration of dissolved TiO₂, the denser the SiO₂ skin on the pigment surface.

### Specific Surface Area According to Bet (Brunauer-Emmett-Teller):

The BET surface of the pigment is measured according to the static volumetric principle, using a Tristar 3000 from Messrs. Micromeritics.

### Optical Properties and Melt Volume Rate of the Polycarbonate:

Polycarbonate injection mouldings with a pigmentation level of 5% by weight TiO₂ pigment are produced for testing the influence of the TiO₂ pigments on the processing stability of polycarbonate and on the properties of the end product. Measurement of the colour (L*, b*) and melt volume rate (MVR) permits statements regarding molecular changes in the polymer caused by hydrolytic and oxidative chemical reactions.

The polycarbonate used is Makrolon 2408. The pigment and the polycarbonate powder are used to prepare 300 g premix, which is dried in a vacuum oven (400 mbar) at 120° C. for 1 hour and then processed on an injection moulding machine (Arburg Allrounder 270U).

The optical properties L* and b* are determined on the injection mouldings using a GretagMacbeth spectrometer (d/8°, D65). A decreasing L* value or an increasing b* value indicates molecular changes in the polymer.

Measurement of the melt volume rate (MVR) according to DIN EN ISO 1133 is performed using crushed polycarbonate injection mouldings, the difference being that the material is heated to 280° C. instead of 300° C. An increase in the MVR value indicates elevated polymer degradation and thus poorer properties of the end product.

### Test Results

TABLE 1
Pigment properties

| | Sulphuric acid solubility | BET |
|---|---|---|
| Pigment | [% by weight] | [m²/g] |
| Example 1 | 4.4 | 8.6 |
| Reference Example 1 | 12.6 | 10.3 |

The test results for sulphuric acid solubility and specific surface area (BET) in Table 1 show that the pigment provided with a SiO₂ layer and a Al₂O₃ layer. (Example 1) displays a denser coating compared to the reference pigment coated only with SiO₂ (Reference Example 1) and thus displays improved weather resistance.

TABLE 2
Polycarbonate properties

| | L* | b* | MVR [cm³/10 min] |
|---|---|---|---|
| Example 2 | 97.8 | 2.1 | 10.9 |
| Example 3 | 98.0 | 1.7 | 10.8 |
| Example 4 | 98.0 | 2.0 | 10.6 |
| Reference Example 2 | 98.1 | 1.7 | 10.8 |
| Reference Example 3 | 97.7 | 2.8 | 13.0 |
| KRONOS 2233 | 97.8 | 2.5 | 11.4 |
| Makrolon 2408 natural | — | — | 10.1 |

Table 2 shows the test results for the polycarbonate properties. The tone b* of the polycarbonate pigmented with the pigments according to the invention (Examples 2, 3, 4) is a slight improvement compared to the commercially available polycarbonate pigment KRONOS 2233, as is the melt volume rate (MVR). Compared to a TiO₂ pigment surface-treated in the sand mill (Reference Example 2), equally good polycarbonate properties are achieved with the pigments according to the invention. However, there are advantages as regards filterability in pigment production (see FIGURE).

Polycarbonates pigmented with pigments having an Al₂O₃ content in excess of 2.4% by weight (Reference Example 3) display poorer optical properties (b*) and processing stability (MVR).

The titanium dioxide pigment provided with the surface coating according to the invention is more weather-resistant compared to the commercially available pigments and improves the processing stability of engineering plastics, particularly of polycarbonate. At the same time, compared to the coating method in the sand mill, the method according to the invention for applying the inorganic surface coating has advantages as regards filter cake filtration.

1. A surface-treated titanium dioxide pigment particle comprising:
a SiO₂ layer, an Al₂O₃ layer and an organic layer applied consecutively around the pigment particles, from the inside to the outside, wherein the organic layer contains at least one compound selected from the group comprising of H-siloxanes, silicone oils and organically functionalised polysiloxanes, and wherein the maximum total Al₂O₃ content of the particles is about 2.4% by weight, referred to total pigment.

2. The surface-treated titanium dioxide pigment particle of claim 1, wherein the total Al₂O₃ content of the particles is a maximum of about 2.0% by weight, referred to total pigment.

3. The surface-treated titanium dioxide pigment particle of claim 1, wherein the total Al₂O₃ content of the particles from about 1.6% to 1.8% by weight, referred to total pigment.

4. The surface-treated titanium dioxide pigment particle of claim 1, wherein the SiO₂ layer contains about 0.5 to 5.0% by weight SiO₂, referred to total pigment.

5. The surface-treated titanium dioxide pigment particle of claim 1, wherein the SiO₂ layer contains 2.0% to 2.5% by weight SiO₂, referred to total pigment.

6. The surface-treated titanium dioxide pigment particle of claim 1, wherein the organic layer consists of polymethylhydrogensiloxane and polydimethylsiloxane.

7. The surface-treated titanium dioxide pigment particle of claim 1, wherein the organic layer contains about 0.05% to 1.0% by weight carbon, referred to total pigment.

8. The surface-treated titanium dioxide pigment particle of claim 1, wherein the organic layer contains about 0.1% to 0.6% by weight carbon, referred to total pigment.

9. A method for manufacturing a surface-treated titanium dioxide pigment particle, comprising the following steps:
a) subjecting an aqueous suspension of Al-doped titanium dioxide particles to agitator milling,
b) applying an SiO₂ layer and an Al₂O₃ layer to titanium dioxide particles in batch mode, where the maximum total Al₂O₃ content of the particles is about 2.4% by weight, referred to total pigment, and
c) subsequently applying an organic layer, comprising at least one compound selected from the group consisting of H-siloxanes, silicone oils and organically functionalised polysiloxanes, to the titanium dioxide particles.

10. The method of claim 9, wherein the Al₂O₃ layer contains about 0.1% to 1.0% by weight Al₂O₃, referred to total pigment.

11. The method of claim 9, wherein the Al₂O₃ layer contains about 0.2% to 0.6% by weight Al₂O₃, referred to total pigment.

12. The method of claim 9, wherein the total Al₂O₃ content of the particles is a maximum of about 2.0% by weight, referred to total pigment.

13. The method of claim 9, wherein the total Al₂O₃ content of the particles is from about 1.6% to 1.8% by weight, referred to total pigment.

14. The method of claim 9 wherein the SiO₂ layer contains about 0.5% to 5.0% by weight SiO₂, referred to total pigment.

15. The method of claim 9 wherein the SiO₂ layer contains about 2.0% to 2.5% by weight SiO₂, referred to total pigment.

16. The method of claim 9 wherein the organic layer comprises polymethylhydrogensiloxane and polydimethylsiloxane.

17. The method of claim 9, wherein the organic layer contains 0.05 to 1.0% by weight carbon, referred to total pigment.

18. The method of claim 9, wherein the organic layer contains about 0.1% to 0.6% by weight carbon, referred to total pigment.

19. The method of claim 9, wherein the titanium dioxide particles are subjected to thermal treatment at about 200 to 600° C., prior to step c).

20. The method of claim 9, wherein the titanium dioxide particles are subjected to thermal treatment at about 300 to 500° C., prior to step c).

21. A plastic comprising a surface-treated titanium dioxide particle according to claim 1.

22. A polymer compound containing an engineering plastic and surface-treated titanium dioxide particle according to claim 1.

23. The method of claim 9 further comprising the step of incorporating said particle into a polymer.

24. The surface-treated titanium dioxide particle produced by the method of claim 9.
